(19) United States
(12) Patent Application Publication
(10) Pub. No.: US 2007/0131348 A1
(43) Pub. Date: Jun. 14, 2007

(54) Process for laser welding

(76) Inventors: Katsuhiko Nakajima, Aichi-ken (JP); Hideo Nakamura, Aichi-ken (JP); Toshio Watanabe, Aichi-ken (JP); Hiroshi Mori, Tokyo (JP); Mitsunobu Nakatani, Tochigi-ken (JP); Makiko Ueda, Tochigi-ken (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/581,639

(22) Filed: Oct. 16, 2006

Related U.S. Application Data
(60) Provisional application No. 60/728,405, filed on Oct. 19, 2005.

(51) Int. Cl. B32B 37/00

(52) U.S. Cl. 156/272.8; 428/304.4

(57) ABSTRACT

A process for laser welding objects comprising the thermoplastic polymer compositions comprising a material having voids.

### CROSS REFERENCE TO RELATED APPLICATIONS

This application claims the benefit of priority to U.S. Provisional Application No. 60/728,405, filed Oct. 19, 2005.

### FIELD OF THE INVENTION

The present invention relates to a process for laser welding objects comprising the thermoplastic polymer compositions comprising a material having voids.

### BACKGROUND OF THE INVENTION

It is often desired to produce molded polymeric parts that can be mechanically assembled into more complex parts. Traditionally, plastic parts have been assembled by gluing or bolting them together or using snap-fit connections or using chemical means such as adhesives. These methods suffer from the drawback that they can add complicated additional steps to the assembly process. Snap-fit connections are often not gas- and liquid-tight and can require complex designs. Newer techniques are vibration and ultrasonic welding, but these can also require complex part designs and welding apparatuses. Additionally, the friction from the process can generate dust that can contaminate the inside of the parts. This is a particular problem when sensitive electrical or electronic components are involved.

A more recently developed technique is laser welding. In this method, two polymeric objects to be joined have different levels of light transmission at the wavelength of the laser that is used. One object is at least partially transparent to the wavelength of the laser light (and referred to as the “relatively transparent” object), while the second part absorbs a significant portion of the incident radiation (and is referred to as the “relatively opaque” object). Each of the objects presents a faying surface and the relatively transparent object presents an impinging surface, opposite the faying surface thereof. The faying surfaces are brought into contact, thus forming a juncture. A laser beam is directed at the impinging surface of the relatively transparent object such that it passes through the first object and irradiates the faying surface of the second object, causing the first and second objects to be welded at the juncture of the faying surfaces. See generally U.S. Pat. No. 5,893,959, which is hereby incorporated by reference herein, and JP S60-214931 A and JP S62-142092 A. This process can be very clean, simple, and fast and provides very strong, easily reproducible welds and significant design flexibility.

However, some materials can be difficult to laser weld and various additives may be added to the compositions to improve laser weldability.

A resin material suitable for laser welding that has a balance of excellent heat resistance, dimensional stability, and laser weldability is described in JP 2004-250621 A. The materials used contain filler such as glass.

JP 2004-268427 A describes a molded polymeric article that comprises a first polymeric molded part having a transmissivity of 15 to 80 percent to light having a wavelength of 500 to 1200 nm and a second polymeric part that is made by foaming molding and contains glass filler and has a light transmissivity of 0.1 to 15 percent. Since the second part can be used as the relatively opaque article in a laser welding process without the addition of a colorant, it can be molded in its natural color.

### SUMMARY OF THE INVENTION

There is disclosed and claimed herein a process for welding a first polymeric object to second polymeric object using laser radiation, wherein the first polymeric object is relatively transparent to the laser radiation and the second object is relatively opaque to the laser radiation, the first and the second objects each presenting a faying surface, the first object presenting an impinging surface, opposite the faying surface thereof, the process comprising the steps of (1) bringing the faying surfaces of the first and second objects into physical contact so as to form a juncture therebetween and (2) irradiating the first and second objects with the laser radiation such that the laser radiation impinges the impinging surface, passes through the first object and irradiates the faying surface of the second object, causing the first and second objects to be welded at the juncture of the faying surfaces, wherein the second polymeric object is formed from a thermoplastic polymer composition comprising a material having voids.

### BRIEF DESCRIPTION OF THE DRAWINGS

FIG. 1(a) is a top view of two test pieces used in laser welding.

FIG. 1(b) is a top view of two test pieces being laser welded.

FIG. 2(a) is a view of a relatively opaque test piece used in the process of laser welding.

FIG. 2(b) is view of a relatively transparent test piece used in the process of laser welding.

FIG. 2(c) is a side view of two test pieces being laser welded.

### DETAILED DESCRIPTION OF THE INVENTION

It has been discovered that a thermoplastic composition for use in forming parts that may be conveniently laser welded using low irradiation energy can be obtained when at least one thermoplastic polymer is melt-blended with at least one material containing voids.

The thermoplastic composition of the present invention preferably has a high thermal conductivity. The composition preferably has a thermal conductivity of about 0.05 to about 0.6 W/mK, or more preferably about 0.1 to about 0.45 W/mK.

Examples of suitable thermoplastic polymers include, but are not limited to, polyacetals, polyesters (including aromatic polyester and aliphatic polyester), liquid crystalline polyesters, polyamides, polyolefins (such as polyethylene and polypropylene), polycarbonates, acrylonitrile-butadiene-styrene polymers (ABS), poly(phenylene oxide)s, poly(phenylene sulfide)s, polysulphones, polyarylates, polyetheretherketones (PEEK), polyetherketoneketones (PEKK), polystyrenes, and syndiotactic polystyrenes. Preferred are polyacetals, polyesters, and polyolefins.

Polymers having low melting points may be preferred for certain applications as they can be welded with less laser energy than polymers having higher melting points. This can reduce welding cycle times and energy consumption, which can lead to a reduction in welding costs.

The polyacetal (also known as polyoxymethylene) can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/or formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and yet more preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy.

Preferred thermoplastic polyesters (which have mostly, or all, ester linking groups) are normally derived from one or more dicarboxylic acids (or their derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other diacids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(trimethylene terephthalate) (PTT), poly(1,4-butylene terephthalate) (PBT), poly(ethylene 2,6-naphthoate), poly(1,4-cyclohexyldimethylene terephthalate) (PCT), a thermoplastic elastomeric polyester having poly(1,4-butylene terephthalate) and poly(tetramethylene ether)glycol blocks (available as Hytrel® from E.I. DuPont de Nemours & Co., Inc., Wilmington, Del. 19898 USA) and copolymers of any of these polymers with any of the above mentioned diols and/or dicarboxylic acids. Suitable polyesters also include liquid crystalline polyesters. Examples of aliphatic polyesters include, but are not limited to poly(epsilon-caprolactam), poly(lactic acid), poly(butylene succinate), and poly(ethylene succinate).

Suitable polyamides can be condensation products of dicarboxylic acids or their derivatives and diamines, and/or aminocarboxylic acids, and/or ring-opening polymerization products of lactams. Suitable dicarboxylic acids include adipic acid, azelaic acid, sebacic acid, dodecanedioic acid, isophthalic acid, and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and pxylylenediamine. A suitable aminocarboxylic acid is 11-aminododecanoic acid. Suitable lactams include caprolactam and laurolactam.

Suitable polyamides include aliphatic polyamides such as polyamide 6; polyamide 6,6; polyamide 4,6; polyamide 6,9; polyamide 6,10; polyamide 6,12; polyamide 10,10; polyamide 11; polyamide 12; semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene isophthalamide and hexamethylene adipamide (polyamide 6,I/6,6); the polyamide of hexamethylene terephthalamide, hexamethylene isophthalamide, and hexamethylene adipamide (polyamide 6,T/6,I/6,6) and copolymers and mixtures of these polymers.

Examples of suitable aliphatic polyamides include polyamide 6,6/6 copolymer; polyamide 6,6/6,8 copolymer; polyamide 6,6/6,10 copolymer; polyamide 6,6/6,12 copolymer; polyamide 6,6/10 copolymer; polyamide 6,6/12 copolymer; polyamide 6/6,8 copolymer; polyamide 6/6,10 copolymer; polyamide 6/6,12 copolymer; polyamide 6/10 copolymer; polyamide 6/12 copolymer; polyamide 6/6,6/6,10 terpolymer; polyamide 6/6,6/6,9 terpolymer; polyamide 6/6,611 terpolymer; polyamide 6/6,6/12 terpolymer; polyamide 6/6,10/11 terpolymer; polyamide 6/6,10/12 terpolymer; and polyamide 6/6,6/PACM (bis-p-[aminocyclohexyl]methane) terpolymer.

The thermoplastic polymer is preferably present in the composition in about 50 to about 99 weight percent, or more preferably in about 70 to about 95 weight percent, based on the total weight of the composition.

The material containing voids preferably has a thermal conductivity of about 2.5 W/mK or less, or more preferably of about 1 W/mK or less, or yet more preferably of about W/mK 0.3 or less.

The material containing voids may have a variety of forms. To increase strength, a hollow spherical form or a hollow platelet form is preferable, and a hollow fiber form is more preferable. Additionally, it is preferred that the material containing voids be treated with a silane or titanate coupling agent to enhance adhesion between the thermoplastic resin and material containing voids.

When the material containing voids is spherical, it is preferred that it have a mean diameter of about 5 to about 500 micrometers. When the material containing voids is in the form of platelets or fibers, it is preferred that they have a mean thickness of about 7 to about 50 micrometers and a mean length of about 100 to about 2000 micrometers. The mean diameters, lengths, and thicknesses can be measured using fiber length distribution measurement equipment and the like.

It is preferred that the material containing voids be an inorganic material, as an inorganic material can help increase the rigidity of the welded object.

A preferred material containing voids is hollow glass. Preferred glasses are silicate glasses (where the term silicate glasses refers to silicon dioxide containing one or more metal ions such as Na⁺, K⁺, Li⁺, Ca2⁺, Mg2⁺, and/or Ba2⁺). The hollow glass preferably has a void diameter or width of at least 5 μm.

Porous silica is another preferred material containing voids. The porous silica preferably has a specific gravity of about 1.8 to about 2.3 g/cm³. Amorphous silicas such as fused silica are preferred porous silicas. A suitable hollow glass is Glass Bubbles S60HS, available from Sumitomo 3M. A suitable silica is Silica MSR-2000, available from Tatsumori.

The material containing voids is preferably present in the composition in about 1 to about 50 weight percent, or more preferably in about 5 to about 30 weight percent, based on the total weight of the composition.

The composition may optionally further contain dyes and/or pigments such as carbon black and nigrosine. When used, the dyes and/or pigments are preferably present in the composition in about 0.05 to about 1 weight percent, or more preferably in about 0.1 to about 0.6 weight percent, based on the total weight of the composition.

The composition may optionally further contain additional components such as one or more antioxidants, pigments, dyes, heat stabilizers, UV light stabilizers, weathering stabilizers, mold release agents, lubricants, nucleating agents, plasticizers, antistatic agents, flame retardants, other polymers, and the like.

The composition used in the present invention is in the form of a melt-mixed blend, wherein all of the polymeric components are well-dispersed within each other and all of the non-polymeric ingredients are dispersed in and bound by the polymer matrix, such that the blend forms a unified whole. The blend may be obtained by combining the component materials using any melt-mixing method. The component materials may be mixed using a melt-mixer such as a single- or twin-screw extruder, blender, kneader, roller, Banbury mixer, etc. to give a resin composition. Or, part of the materials may be mixed in a melt-mixer, and the rest of the materials may then be added and further melt-mixed. The sequence of mixing in the manufacture of the compositions of the invention may be such that individual components may be melted in one shot, or the filler and/or other components may be fed from a side feeder, and the like, as will be understood by those skilled in the art.

The compositions of the present invention may be formed into objects using methods known to those skilled in the art, such as, for example, injection molding, extrusion, blow molding, injection blow molding, compression molding, foaming molding, vacuum molding, rotation molding, calendar molding, solution casting, or the like. The objects comprising the composition of the present invention are laser welded to other objects and may be either the relatively transparent object or, preferably, the relatively opaque object in the laser welding process. Preferred lasers for use in the laser welding process of the present invention are any lasers emitting light having a wavelength within the range of about 800 nm to about 1200 nm. Examples of types of preferred lasers are YAG and diode lasers. Preferred wavelengths are in the near-infrared such as 808, 940, 980 nm, etc.

The composition used for the relatively transparent object used in the laser welding process may have a natural color or may contain dyes that are sufficiently transparent to the wavelength of light used for laser welding. Such dyes may include, for example, anthraquinone-based dyes. The composition used for the relatively transparent object preferably contains glass fibers, which can improve weld strength.

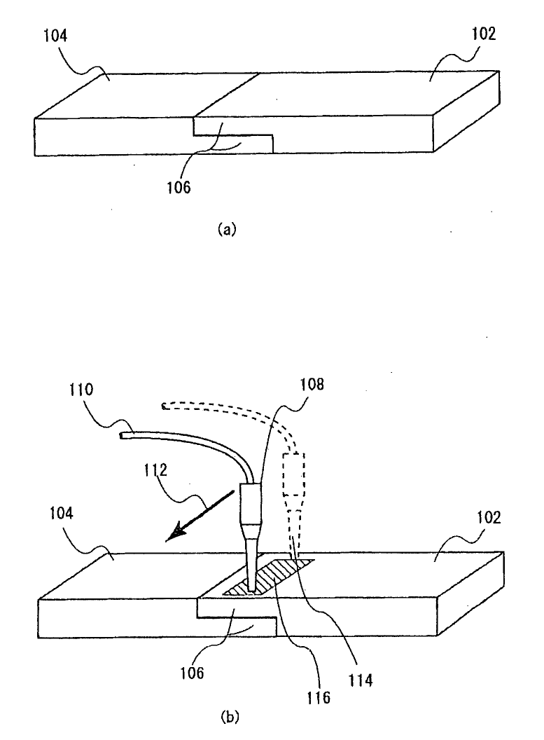

The process of laser welding is illustrated in the figures. Referring to FIG. 1(a), relatively transparent object 102 having a half lap 106 and relatively opaque object 104 having a half lap 106 are placed into contact so as to form a juncture between half laps 106. Objects 102 and 104 are preferably immobilized and held firmly together by using, for example, a clamp, air pressure, or other suitable means (not shown).

Referring to FIG. 1(b), laser light 114 (supplied from the laser (not shown) by optical fiber 110 through laser irradiator 108) is passed across the impinging surface 116 of relatively transparent object 102 in direction 112. The light passes through relatively transparent object 102 and irradiates the surface of half lap 106 of relatively opaque object 104, causing the polymer at the surface of object 104 to be melted and causing objects 102 and 104 to be welded at the juncture.

The motion of laser irradiator 108 as it is scanned across impinging surface 116 may be controlled by the arm (not shown) of an industrial robot into which information such as the scanning path is programmed. Alternatively, the objects 102 and 104 may be affixed to an XYZ stage and moved relative to a stationary laser irradiator. Any suitable alternative means of moving the objects to be welded and laser light relative to each other may also be used. The speed of scanning can differ depending on the materials to be welded. For example, for a polyolefin resin such as polypropylene, a scanning speed of about 200 to about 1000 cm/min can be used. In addition, the laser power necessary to effect an effective weld can also vary according to the materials to be welded. For example, for a polyolefin resin such as polypropylene a laser power of about 10 to 180 W can be used.

The welding path may be linear as illustrated in FIG. 1(b), or may take on a different, non-linear or partially non-linear form. The objects to be welded may take a wide variety of forms and shapes, such as discs, cylinders, hemispheres, and irregular shapes. The impinging surfaces of the objects may also have a uniform thickness along the welding path or the thickness may vary.

Although the thickness of the relatively transparent object at points to be laser welded is not particularly limited as long as welding is possible, the thickness of such parts at such points is preferably about 10 mm or less, or more preferably about 0.5 to about 4 mm.

The present invention also includes any laser-welded article made from the process of the invention. Useful articles include articles for use in electrical and electronic applications, automotive components, office equipment parts, building materials, parts for industrial equipment such as conveyors, parts for medical devices, and parts for consumer goods such as toys and sporting goods. Examples of automotive components include engine compartment components, intake manifolds, underhood parts, radiator components, cockpit instrument panel components. Useful electrical and electronic components include sensor housings, personal computers, liquid crystal projectors, mobile computing devices, cellular telephones, and the like. Examples of office equipment parts are parts for printers, copiers, fax machines, and the like.

### EXAMPLES

### Example 1

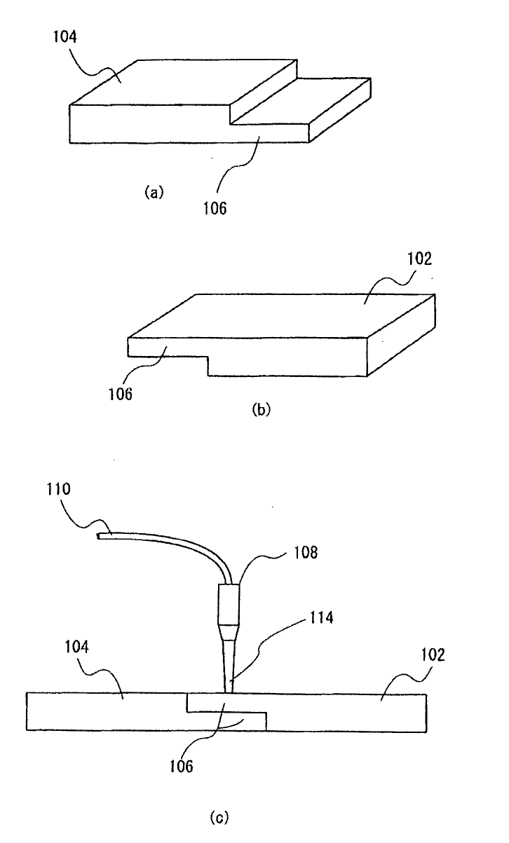

Polypropylene (NovaTech PP MA3AH, manufactured by Japan Polypropylene Inc.) (94.4 weight percent), hollow glass (Glass Bubbles S60 HS, available from Sumitomo 3M.) (5 weight percent), and carbon black (0.6 weight percent) were melt-blended in a twin-screw extruder. Referring to FIG. 2(a), this composition was injection molded into relatively opaque object 104. Object 104 had a length of 80 mm and a width of 18 mm. The thickness of object 104 was 3 mm in its thickest portion and 1.5 mm at half lap 106.

Referring to FIG. 2(b), Polypropylene (NovaTech PP MA3AH, manufactured by Japan Polypropylene Inc.) was molded into relatively transparent object 102 having the same dimensions as relatively opaque object 104.

Referring to FIG. 2(c), objects 102 and 104 were placed into contact so as to form a juncture between half laps 106. Objects 102 and 104 were welded together using a laser manufactured by Rofin-Sinar of Germany (not shown) operating at a wavelength of 940 nm and having a focusing diameter of 3 mm and a maximum power of 500 W. The laser light 114 was conducted from the laser to objects 102 and 104 via optical fiber 110 and laser irradiator 108). The laser scanning speed varied in the range of 3 to 7 cm/sec and the laser power was varied from 10 to 40 W in different trials.

The tensile shear strength of the resulting welds were determined by clamping the shoulders of the resulting welded articles in a tensile strength tester manufactured by Shimadzu Corp. and applying a tensile force in the longitudinal direction of the welded articles. The tester was operated at a rate of 2 mm/min. For each sample, the tensile shear strength was plotted as a function of laser energy. The points were fit to a curve. The point on the curve corresponding the maximum of the curve (i.e., the maximum weld strength) was located and the corresponding maximum shear strength was determined. A value corresponding to 90% of this maximum shear strength was calculated and the point on curve closest to the y-axis corresponding to 90% of the maximum shear strength was located. The laser energy corresponding to that point is referred to herein as F₉₀ and was determined to be 0.10 J/mm².

### Example 2

Example 2 was performed following the same procedure as was used in Example 1, except that 15 weight percent of hollow glass was used. F₉₀ was 0.08 J/mm².

### Example 3

Example 3 was performed following the same procedure as was used in Example 1, except that 30 weight percent of hollow glass was used. F₉₀ was 0.06 J/mm².

### Example 4

Example 4 was performed following the same procedure as was used in Example 1, except that 20 weight percent of silica (Silica MSR-2000, available from Tatsumori) was used instead of hollow glass. F₉₀ was 0.10 J/mm².

### Comparative Example 1

Comparative Example 1 was performed following the same procedure as was used in Example 1, except that polypropylene (NovaTech PP MA3AH, manufactured by Japan Polypropylene Inc.) (99.4 weight percent) and carbon black (0.6 weight percent) were melt-blended in a twin-screw extruder and molded into relatively opaque object 104. F₉₀ was 0.12 J/mm².

The results for each example and the comparative example are summarized in Table 1 and demonstrate that when objects comprising polymeric compositions comprising hollow glass or silica are welded, it is necessary to use less energy to obtain high weld strengths. This can result in an increase in efficiency and cost reduction in laser welding operations.

TABLE 1

| | Additive | F₉₀ (J/mm²) |
|---|---|---|
| Example 1 | 5 weight percent hollow glass | 0.10 |
| Example 2 | 15 weight percent hollow glass | 0.08 |
| Example 3 | 30 weight percent hollow glass | 0.06 |
| Example 4 | 20 weight percent silica | 0.10 |
| Comp. Ex. 1 | None | 0.12 |

What is claimed is:

1. A process for welding a first polymeric object to second polymeric object using laser radiation, wherein the first polymeric object is relatively transparent to the laser radiation and the second object is relatively opaque to the laser radiation, the first and the second objects each presenting a faying surface, the first object presenting an impinging surface, opposite the faying surface thereof, the process comprising the steps of (1) bringing the faying surfaces of the first and second objects into physical contact so as to form a juncture therebetween and (2) irradiating the first and second objects with the laser radiation such that the laser radiation impinges the impinging surface, passes through the first object and irradiates the faying surface of the second object, causing the first and second objects to be welded at the juncture of the faying surfaces, wherein the second polymeric object is formed from a,, thermoplastic polymer composition comprising a material having voids.

2. The process of claim 1, wherein the material having voids is hollow glass.

3. The process of claim 1, wherein the material having voids is porous silica.

4. The process of claim 1, wherein the material containing voids has a thermal conductivity of 2.5 W/mK or less.

5. The process of claim 1, wherein the material containing voids has a thermal conductivity of 1 W/mK or less.

6. The process of claim 1, wherein the material containing voids has a thermal conductivity of 0.3 W/mK or less.

7. The process of claim 1, wherein the material containing voids is spherical and has a mean diameter of about 5 to about 500 micrometers.

8. The process of claim 1, wherein the material containing voids is in the form of platelets or fibers and has a mean thickness of about 7 to about 50 micrometers and a mean length of about 100 to about 2000 micrometers.

9. The process of claim 3, wherein the porous silica has a specific gravity of about 1.8 to about 2.3 g/cm³.

10. The process of claim 3, wherein the porous silica is fused silica.

11. The process of claim 1, wherein the thermoplastic polymer composition comprises about 1 to about 50 weight percent of the material having voids, based on the total weight of the composition.

12. The process of claim 1, wherein the thermoplastic polymer is one or more selected from the group consisting of polyolefin, polyacetal, polyamide, and polyester.

13. A laser welded article made by the process of claim 1.

14. The article of claim 13 in the form of an automotive component.

15. A resin composition for laser welding comprising a thermoplastic resin comprising a material having voids.

16. The resin composition of claim 15, wherein the material having voids is hollow glass or silica.

17. The resin composition of claim 15, wherein the material having voids is hollow glass.

18. The resin composition of claim 15, wherein the material having voids is present in about 1 to about 50 weight percent, based on the total weight of the composition.

19. The resin composition of claim 15, wherein the thermoplastic polymer is selected from the group consisting of polyolefin, polyacetal, and polyester.

20. An article comprising the resin composition of claim 15.

21. The article of claim 20 in the form of an automobile part.
